(19) United States
(12) Patent Application Publication
(10) Pub. No.: US 2015/0055682 A1
(43) Pub. Date: Feb. 26, 2015

(54) FILM-TYPE THERMISTOR SENSOR

(71) Applicant: MITSUBISHI MATERIALS CORPORATION, Tokyo (JP)

(72) Inventors: Noriaki Nagatomo, Naka-shi (JP); Hiroshi Tanaka, Naka-shi (JP); Hitoshi Inaba, Naka-shi (JP); Kenji Kubota, Naka-shi (JP)

(21) Appl. No.: 14/389,271

(22) PCT Filed: Mar. 25, 2013
(86) PCT No.: PCT/JP2013/059797

§ 371 Date: Sep. 29, 2014

(30) Foreign Application Priority Data
Mar. 30, 2012 (JP) 2012-081106

(51) Int. Cl. G01K 7/22; G01K 1/14

(52) U.S. Cl. CPC G01K 7/226; G01K 1/143
USPC 374/185

(57) ABSTRACT

Provided is a film-type thermistor sensor which can be surface-mounted and can be directly deposited on a film or the like without baking. The film-type thermistor sensor includes an insulating film; a thin-film thermistor part formed on the front side of the insulating film; the pair of front side pattern electrodes in which a pair of counter electrode parts facing each other is disposed above or below the thin-film thermistor part and is formed on the front side of the insulating film; and a pair of back side pattern electrodes formed on the back side of the insulating film in such a manner as to face a part of the pair of front side pattern electrodes, wherein the front side pattern electrodes and the back side pattern electrodes are electrically connected via via-holes formed so as to penetrate the insulating film.

### BACKGROUND OF THE INVENTION

1. Field of the Invention

The present invention relates to a film-type thermistor sensor which is suitably used as a temperature sensor which is surface-mountable on a substrate.

2. Description of the Related Art

There has been a requirement for a thermistor material used for a temperature sensor or the like to exhibit a high constant B so as to obtain a high precision and high sensitivity thermistor sensor. Conventionally, transition metal oxides such as Mn, Co, Fe, and the like are typically used as such thermistor materials (see Patent Documents 1 and 2). These thermistor materials need to be fired at a temperature of 600° C. or greater in order to obtain a stable thermistor characteristic.

In addition to thermistor materials consisting of metal oxides as described above, Patent Document 3 discloses a thermistor material consisting of a nitride represented by the general formula: MₓA_{y}N_{z} (where M represents at least one of Ta, Nb, Cr, Ti, and Zr, A represents at least one of Al, Si, and B, 0.1≦x≦0.8, 0<y≦0.6, 0.1≦z≦0.8, and x+y+z=1). In Patent Document 3, only a Ta—Al—N-based material represented by MₓA_{y}N_{z} (where 0.5≦x≦0.8, 0.1≦y≦0.5, 0.2≦z≦0.7, and x+y+z=1) is described in Example. The Ta—Al—N-based material is produced by sputtering in a nitrogen gas-containing atmosphere using a material containing the elements as set forth as a target. The obtained thin film is subject to a heat treatment at a temperature from 350 to 600° C. as required.

### PRIOR ART DOCUMENTS

### Patent Documents

[Patent Document 1] Japanese Unexamined Patent Application Publication No. 2003-226573

[Patent Document 2] Japanese Unexamined Patent Application Publication No. 2006-324520

[Patent Document 3] Japanese Unexamined Patent Application Publication No. 2004-319737

### SUMMARY OF THE INVENTION

### Problems to be Solved by the Invention

The following problems still remain in the conventional techniques described above.

In recent years, the development of a film-type thermistor sensor made of a thermistor material on a resin film has been considered, and thus, it has been desired to develop a thermistor material which can be directly deposited on a film. Specifically, it is expected to obtain a flexible thermistor sensor by using a film. Furthermore, although it is desired to develop a very thin thermistor sensor having a thickness of about 0.1 mm, a substrate material using a ceramics material such as alumina has often conventionally used. For example, if the substrate material is thinned to a thickness of 0.1 mm, the substrate material is very fragile and easily breakable. Thus, it is expected to obtain a very thin thermistor sensor by using a film.

Conventionally, in a temperature sensor formed by a thin-film thermistor material layer, the thin-film thermistor material layer is formed by laminating a thermistor material layer and an electrode layer to the surface of a film, and the temperature sensor is electrically connected to an external circuit or the like via a lead wire which is connected to the electrode layer on the surface of the film by soldering or the like. However, in such a connection structure, the temperature sensor cannot be directly surface-mounted on the substrate so as to provide electrical connection.

In addition, a film made of a resin material typically has a low heat resistance temperature of 150° C. or lower, and even polyimide which is known as a material relatively having a high heat resistance temperature only has a heat resistance temperature of about 200° C. Hence, when a heat treatment is performed in steps of forming a thermistor material, it has been conventionally difficult to use such a thermistor material. The above conventional oxide thermistor material needs to be fired at a temperature of 600° C. or higher in order to realize a desired thermistor characteristic, so that a film-type thermistor sensor which is directly deposited on a film cannot be realized. Thus, it has been desired to develop a thermistor material which can be directly deposited on a film without baking. However, even in the thermistor material disclosed in Patent Document 3, there has remained the need to perform a heat treatment for the obtained thin film at a temperature from 350 to 600° C. as required in order to obtain a desired thermistor characteristic. As the thermistor material, although a material having a constant B of about 500 to 3000 K was obtained in Example of a Ta—Al—N-based material, there is no description regarding heat resistance, and thus, the thermal reliability of a nitride-based material has been unknown.

The present invention has been made in view of the aforementioned circumstances, and an object of the present invention is to provide a film-type thermistor sensor which is surface-mountable and can be further directly deposited on a film without baking.

### Means for Solving the Problems

The present invention adopts the following structure in order to solve the aforementioned problems. Specifically, a film-type thermistor sensor according to a first aspect of the present invention is characterized in that the film-type thermistor sensor includes an insulating film; a thin-film thermistor part formed on the front side of the insulating film; a pair of front side pattern electrodes in which a pair of counter electrode parts facing each other is disposed above or below the thin-film thermistor part and is formed on the front side of the insulating film; and a pair of back side pattern electrodes formed on the back side of the insulating film in such a manner as to face a part of the pair of front side pattern electrodes, wherein the front side pattern electrodes and the back side pattern electrodes are electrically connected via via-holes formed so as to penetrate the insulating film.

Specifically, since, in the film-type thermistor sensor, the front side pattern electrodes and the back side pattern electrodes are electrically connected via via-holes formed so as to penetrate the insulating film with the thin-film thermistor part formed thereon, the film-type thermistor sensor can be directly surface-mounted on a circuit board or the like, so that the back side pattern electrodes or the front side pattern electrodes can be served as terminal portions for electrical connection. Thus, the film-type thermistor sensor which is thin and surface-mountable improves the responsiveness of temperature measurement and can be mounted in small space below an IC or the like mounted on a circuit board or the like. This also allows direct measurement of a temperature of an IC directly below the IC.

In addition, since the front side pattern electrodes and the back side pattern electrodes serving as terminal portions are respectively formed on the front side and the back side of the insulating film, the film-type thermistor sensor can be surface-mounted without differentiating between front and back. Even if either side of the film-type thermistor sensor is surface-mounted, the use of the thin insulating film brings little difference in responsiveness. Furthermore, since the front side pattern electrodes are connected to the back side pattern electrodes via via-holes, the insulating film is difficult to be peeled off from the front side pattern electrodes or the back side pattern electrodes upon solder mounting due to the anchoring effect. In particular, since the film-type thermistor sensor is in a film type using the thin-film thermistor part which is surface-mountable even if it is bent to some extent, the effects specific to a film type sensor, such as the establishment of an electric connection to the back side of the film-type thermistor sensor through via-holes for use with semiconductor technology and the suppression of occurrence of cracking or peeling even in a bent or flexed state due to the anchoring effect of the via-holes, can be obtained.

A film-type thermistor sensor according to a second aspect of the present invention is characterized in that the via-holes are disposed in plural for each of the front side pattern electrodes and are formed at least near the corners of the front side pattern electrodes or the back side pattern electrodes according to the first aspect of the present invention.

Specifically, since, in the film-type thermistor sensor, the via-holes are disposed in plural for each of the front side pattern electrodes and are formed at least near the corners of the front side pattern electrodes or the back side pattern electrodes, a stronger anchoring effect can be obtained, resulting in an improvement in adhesive strength near the corners of pattern electrodes which are particularly and readily peeled off.

A film-type thermistor sensor according to a third aspect of the present invention is characterized in that the film-type thermistor sensor according to the first or second aspect of the present invention further includes a protective film formed by a resin deposited on the thin-film thermistor part.

Specifically, since the film-type thermistor sensor includes a protective film formed by a resin deposited on the thin-film thermistor part, the thin-film thermistor part can be insulated from a substrate or an IC by the presence of the protective film even when the film-type thermistor sensor is surface-mounted with the front side of the insulating film directed toward the substrate or is mounted below the IC. In addition, since the thin-film thermistor part is disposed between the insulating film and the protective film so as to be located approximately at the center in the direction of thickness of the film-type thermistor sensor, little difference in responsiveness occurs even when the film-type thermistor sensor is surface-mounted without differentiating between front and back.

A film-type thermistor sensor according to a fourth aspect of the present invention is characterized in that the thin-film thermistor part consists of a metal nitride represented by the general formula: TiₓAl_{y}N_{z} (where 0.70≦y/(x+y)≦0.95, 0.4≦z≦0.5, and x+y+z=1), and the crystal structure thereof is a hexagonal wurtzite-type single phase according to any one of the first to third aspects of the present invention.

The present inventors' serious endeavor by focusing on an AlN-based material among nitride materials found that the AlN-based material having a good constant B and exhibiting excellent heat resistance may be obtained without baking by substituting Al-site with a specific metal element for improving electric conductivity and by ordering it into a specific crystal structure because AlN is an insulator and it is difficult for AlN to obtain an optimum thermistor characteristic (constant B: about 1000 to 6000 K).

Thus, the present invention has been obtained on the basis of the above finding. Since the thin-film thermistor part consists of a metal nitride represented by the general formula: TiₓAl_{y}N_{z} (where 0.70≦y/(x+y)≦0.95, 0.4≦z≦0.5, and x+y+z=1), wherein the crystal structure thereof is a hexagonal wurtzite-type single phase, the metal nitride material having a good constant B and exhibiting excellent heat resistance may be obtained without baking.

Note that, when the value “y/(x+y)” (i.e., Al/(Ti+Al)) is less than 0.70, a wurtzite-type single phase is not obtained but two coexist phases of a wurtzite-type phase and a NaCl-type phase or a single phase of only a NaCl-type phase may be obtained, so that a sufficiently high resistance and a high constant B cannot be obtained.

When the ratio of “y/(x+y)” (i.e., Al/(Ti+Al)) exceeds 0.95, the metal nitride material exhibits very high resistivity and extremely high electrical insulation, so that the metal nitride material is not applicable as a thermistor material.

When the ratio of “z” (i.e., N/(Ti+Al+N)) is less than 0.4, the amount of nitrogen contained in the metal is small, so that a wurtzite-type single phase cannot be obtained. Consequently, a sufficiently high resistance and a high constant B cannot be obtained.

Furthermore, when the ratio of “z” (i.e., N/(Ti+Al+N)) exceeds 0.5, a wurtzite-type single phase cannot be obtained. This is because a correct stoichiometric ratio of N/(Ti+Al+N) in a wurtzite-type single phase when there is no defect at nitrogen-site is 0.5.

### Effects of the Invention

According to the present invention, the following effects may be provided.

Specifically, according to the film-type thermistor sensor of the present invention, the front side pattern electrodes and the back side pattern electrodes are electrically connected via via-holes formed so as to penetrate the insulating film with the thin-film thermistor part formed thereon, and thus, the film-type thermistor sensor is surface-mountable on a circuit board or the like without differentiating between front and back.

Furthermore, the thin-film thermistor part consists of a metal nitride represented by the general formula: TiₓAl_{y}N_{z} (where 0.70≦y/(x+y)≦0.95, 0.4≦z≦0.5, and x+y+z=1), and the crystal structure thereof is a hexagonal wurtzite-type single phase, the metal nitride material having a good constant B and exhibiting excellent heat resistance may be obtained without baking.

Thus, the film-type thermistor sensor of the present invention is a thin, flexible, exhibits excellent responsiveness, is surface-mountable on various locations such as within a mobile device, below an IC or the like mounted on a circuit board within a mobile device, and the like, and can perform temperature measurement with high precision.

### BRIEF DESCRIPTION OF THE DRAWINGS

FIG. 1 is an example of a cross-sectional view, a plan view, and a back side view illustrating a film-type thermistor sensor according to a first embodiment of the present invention.

FIG. 2 is a Ti—Al—N-based ternary phase diagram illustrating the composition range of a metal nitride material for a thermistor according to the first embodiment.

FIG. 3 is an example of a cross-sectional view and a plan view illustrating a step of forming a thin-film thermistor part according to the first embodiment.

FIG. 4 is an example of a cross-sectional view and a plan view illustrating a step of forming a through hole for a via-hole according to the first embodiment.

FIG. 5 is an example of a cross-sectional view, a plan view, and a back side view illustrating a step of forming an electrode layer and a via-hole according to the first embodiment.

FIG. 6 is an example of a cross-sectional view, a plan view, and a back side view illustrating a patterning step of forming a dry film according to the first embodiment.

FIG. 7 is an example of a cross-sectional view, a plan view, and a back side view illustrating a patterning step of forming a pattern electrode according to the first embodiment.

FIG. 8 is an example of a cross-sectional view and a plan view illustrating a patterning step of forming a protective film according to the first embodiment.

FIG. 9 is an example of a cross-sectional view and a plan view illustrating a step of filling a via-hole with copper plating according to the first embodiment.

FIG. 10 is an example of a cross-sectional view, a plan view, and a back side view illustrating a film-type thermistor sensor according to a second embodiment of the present invention.

FIG. 11 is a front view and a plan view illustrating a film evaluation element for a metal nitride material for a thermistor according to Example of a film-type thermistor sensor of the present invention.

FIG. 12 is a graph illustrating the relationship between a resistivity at 25° C. and a constant B according to Examples and Comparative Example of the present invention.

FIG. 13 is a graph illustrating the relationship between the Al/(Ti+Al) ratio and the constant B according to Examples and Comparative Example of the present invention.

FIG. 14 is a graph illustrating the result of X-ray diffraction (XRD) in the case of a strong c-axis orientation where Al/(Ti+Al)=0.84 according to Example of the present invention.

FIG. 15 is a graph illustrating the result of X-ray diffraction (XRD) in the case of a strong a-axis orientation where Al/(Ti+Al)=0.83 according to Example of the present invention.

FIG. 16 is a graph illustrating the result of X-ray diffraction (XRD) in the case where Al/(Ti+Al)=0.60 according to Comparative Example of the present invention.

FIG. 17 is a graph illustrating the relationship between the Al/(Ti+Al) ratio and the constant B obtained by comparing Example revealing a strong a-axis orientation and Example revealing a strong c-axis orientation according to Examples of the present invention.

FIG. 18 is a cross-sectional SEM photograph illustrating Example revealing a strong c-axis orientation according to Example of the present invention.

FIG. 19 is a cross-sectional SEM photograph illustrating Example revealing a strong a-axis orientation according to Example of the present invention.

### BEST MODES FOR CARRYING OUT THE INVENTION

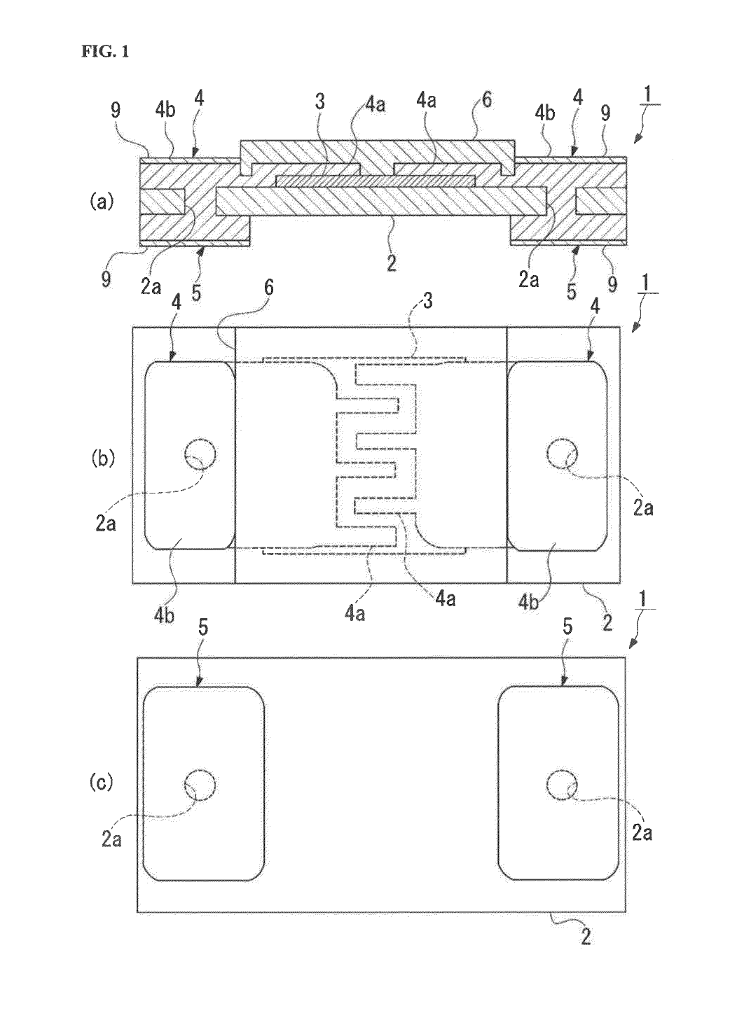

Hereinafter, a description will be given of a film-type thermistor sensor according to a first embodiment of the present invention with reference to FIGS. 1 to 9. In a part of the drawings used in the following description, the scale of each component is changed as appropriate so that each component is recognizable or is readily recognized.

As shown in FIG. 1, a film-type thermistor sensor (1) according to the first embodiment includes an insulating film (2); a thin-film thermistor part (3) formed on the front side of the insulating film (2); a pair of front side pattern electrodes (4) in which a pair of counter electrode parts (4a) facing each other is disposed above the thin-film thermistor part (3) and is formed on the front side of the insulating film (2); a pair of back side pattern electrodes (5) formed on the back side of the insulating film (2) in such a manner as to face a part of the pair of front side pattern electrodes (4); and a protective film (6) formed by a resin deposited on the thin-film thermistor part (3).

Also, the front side pattern electrodes (4) and the back side pattern electrodes (5) are electrically connected via via-holes (2a) formed so as to penetrate the insulating film (2).

The insulating film (2) is, for example, a polyimide resin sheet formed in a band shape. Other examples of the insulating film (2) include polyethylene terephthalate (PET), polyethylene naphthalate (PEN), and the like.

The thin-film thermistor part (3) is formed of a thermistor material of TiAlN. In particular, the thin-film thermistor part (3) consists of a metal nitride represented by the general formula: TiₓAl_{y}N_{z} (where 0.70≦y/(x+y)≦0.95, 0.4≦z≦0.5, and x+y+z=1), and the crystal structure thereof is a hexagonal wurtzite-type single phase.

Each of the front side pattern electrodes (4) and the back side pattern electrodes (5) has a bonding layer of Cr or NiCr and an electrode layer formed of Cu, Au, or the like on the bonding layer.

The pair of front side pattern electrodes (4) has a pair of counter electrode parts (4a) which is a pair of comb shaped electrode portions formed on the thin-film thermistor part (3) so as to be arranged in opposing relation to each other in a comb shaped pattern; and a pair of front side terminal portions (4b) which are connected to the counter electrode parts (4a) and are formed on the front side of the two ends of the insulating film (2).

The pair of back side pattern electrodes (5) is patterned in a substantially rectangular shape on the back side the insulating film (2) at locations opposing to the pair of front side terminal portions (4b).

The via-hole (2a) is formed at the center of the back side pattern electrode (5).

The protective film (6) is patterned by applying, for example, a polyimide resin in a rectangular shape larger than that of the thin-film thermistor part (3).

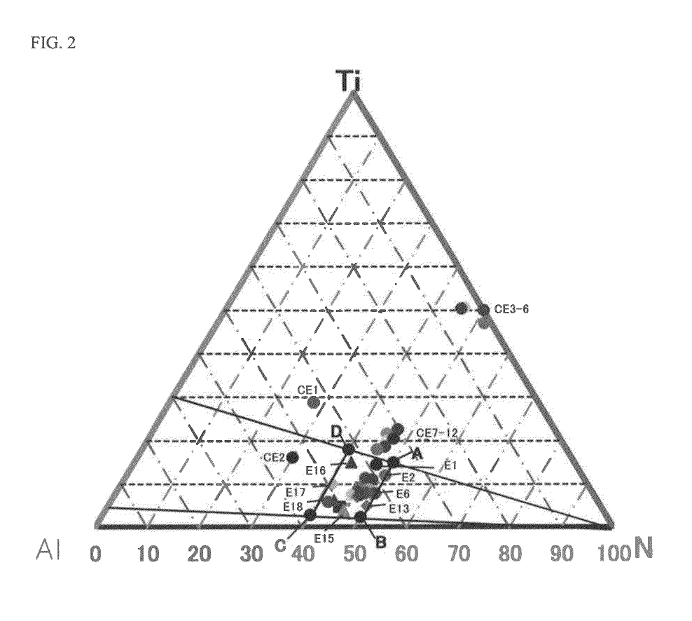

As described above, the thin-film thermistor part (3) is a metal nitride material consisting of a metal nitride represented by the general formula: TiₓAl_{y}N_{z} (where 0.70≦y/(x+y)≦0.95, 0.4≦z≦0.5, and x+y+z=1), wherein the crystal structure thereof is a wurtzite-type (space group P6₃mc (No. 186)) single phase having a hexagonal crystal system. Specifically, the metal nitride material has a composition within the region enclosed by the points A, B, C, and D in the Ti—Al—N-based ternary phase diagram as shown in FIG. 2, wherein the crystal phase thereof is a wurtzite-type metal nitride.

Note that the composition ratios (x, y, z) (atomic %) at the points A, B, C, and D are A (15, 35, 50), B (2.5, 47.5, 50), C (3, 57, 40), and D (18, 42, 40), respectively.

Also, the thin-film thermistor part (3) is formed into the shape of a film and is a columnar crystal extending in a vertical direction to the surface of the film. Furthermore, it is preferable that the thin-film thermistor part (3) is strongly oriented along the c-axis more than the a-axis in a vertical direction to the surface of the film.

Note that the decision on whether the thin-film thermistor part (3) has a strong a-axis orientation (100) or a strong c-axis orientation (002) in a vertical direction (film thickness direction) to the surface of the film is determined whether the peak intensity ratio of “the peak intensity of (100)”/“the peak intensity of (002)” is less than 1 by examining the orientation of crystal axis using X-ray diffraction (XRD), where (100) is the Miller index indicating a-axis orientation and (002) is the Miller index indicating c-axis orientation.

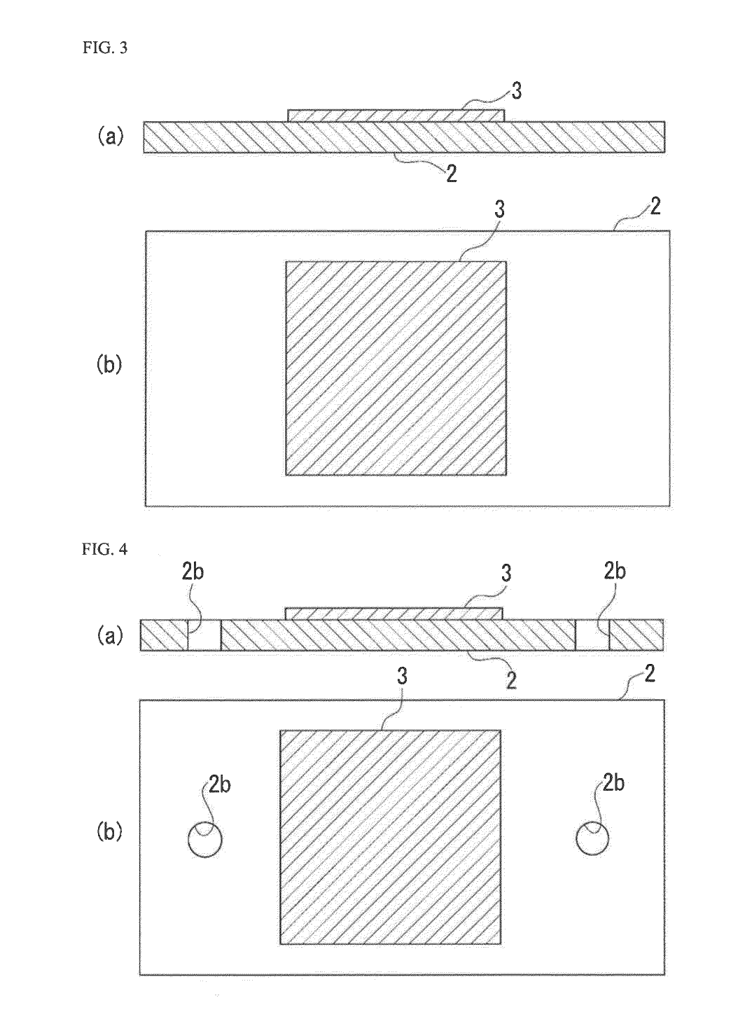

A description will be given below of a method for producing the film-type thermistor sensor (1) with reference to FIGS. 3 to 10.

The method for producing the film-type thermistor sensor (1) of the present embodiment includes a thin-film thermistor part forming step of patterning a thin-film thermistor part (3) on an insulating film (2); a step of forming a pair of through holes (2b) for via-holes (2a) in the insulating film (2); a step of forming the via-holes (2a) by providing a metal film on the inner surfaces of the through holes (2b); an electrode forming step of patterning a pair of front side pattern electrodes (4) on the front side of the insulating film (2) by arranging a pair of counter electrode parts (4a) facing each other on the thin-film thermistor part (3) and patterning a pair of back side pattern electrodes (5) on the back side of the insulating film (2); a step of patterning a protective film (6) on the thin-film thermistor part (3); and a step of filling the via-holes (2a) with a metal.

As a more specific example of such a production method, a thermistor material layer of TiₓAl_{y}N_{z} (x=9, y=43, z=48) having a film thickness of 200 nm is deposited on the front side of the insulating film (2) made of a rectangular shaped polyimide film having a thickness of 25 μm using a Ti—Al alloy sputtering target in the reactive sputtering method in a nitrogen-containing atmosphere. The laminated film is produced under the sputtering conditions of an ultimate degree of vacuum of 5×10⁻6 Pa, a sputtering gas pressure of 0.4 Pa, a target input power (output) of 200 W, and a nitrogen gas fraction under a mixed gas (Ar gas+nitrogen gas) atmosphere of 20%.

Furthermore, a resist solution is coated on the laminated film using a bar coater, and then prebaking is performed for 1.5 mins at a temperature of 110° C. After being exposed by an exposure device, an unnecessary portion is removed by a developing solution, and then pattering is performed by post baking for 5 mins at a temperature of 150° C. Then, an unnecessary thermistor material layer is subject to wet etching using commercially available Ti etchant, and then the resist is stripped so as to form the thin-film thermistor part (3) having the size of 0.8×0.8 mm. As described above, as shown in FIG. 3, the thin-film thermistor part (3) having a square shape is formed at the center of the front side of the insulating film (2). Note that the thin-film thermistor part (3) is hatched as shown in FIGS. 3(b) and 4(b).

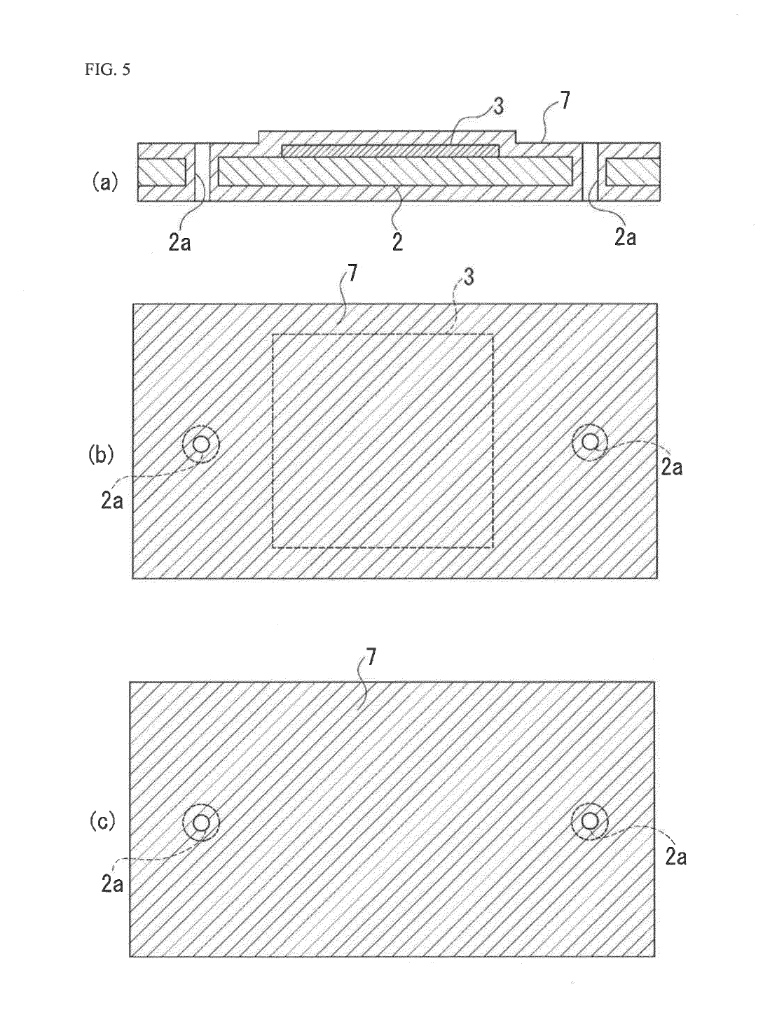

Next, as shown in FIG. 4, two through holes (2b) each having a diameter φ of 25 μm are formed at the center of the region on which the terminal portions (the back side pattern electrodes (5)) of the insulating film (2) are to be formed using an YAG laser. Furthermore, as shown in FIG. 5, a Cr film having a thickness of 20 nm is formed on both sides of the insulating film (2) in the sputtering method, and a Cu film having a thickness of 100 nm is further deposited on the laminated film to thereby form a Cr/Cu film (7). At this time, the Cr film and the Cu film are sequentially deposited from the front side to the back side of the insulating film (2) in a laminated state on the inner surfaces of the through holes (2b) to thereby form the via-holes (2a). Note that the Cr/Cu film (7) is hatched as shown in FIGS. 5(b) and 5(c).

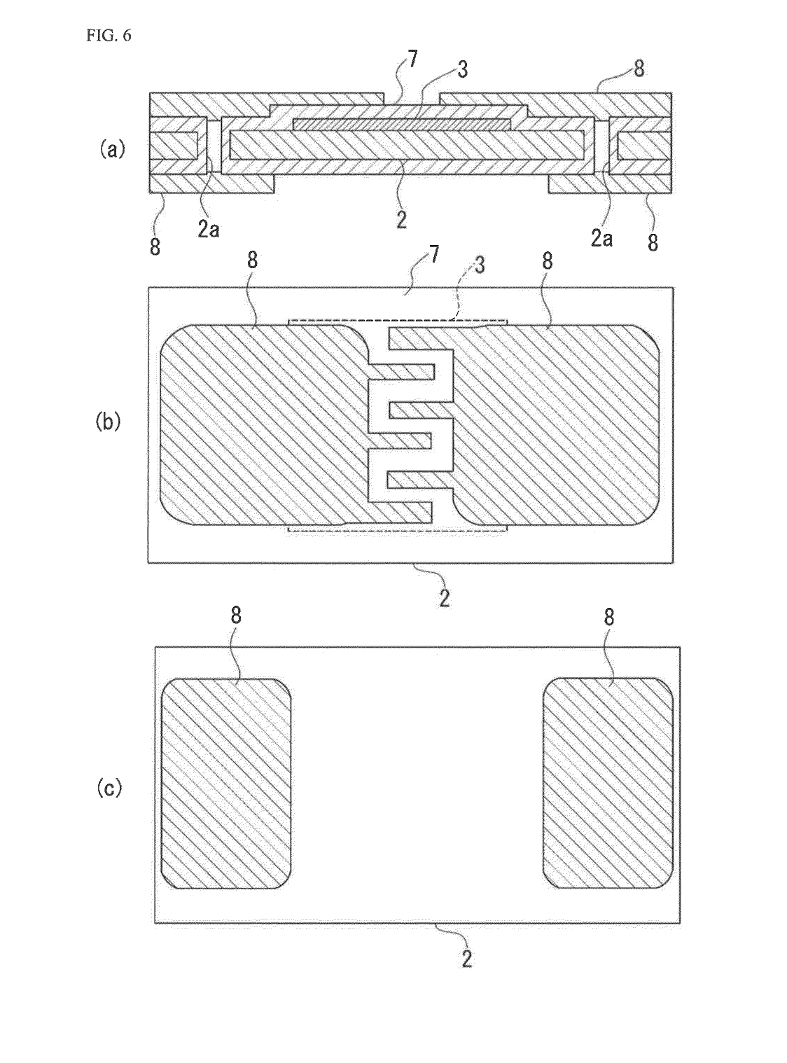

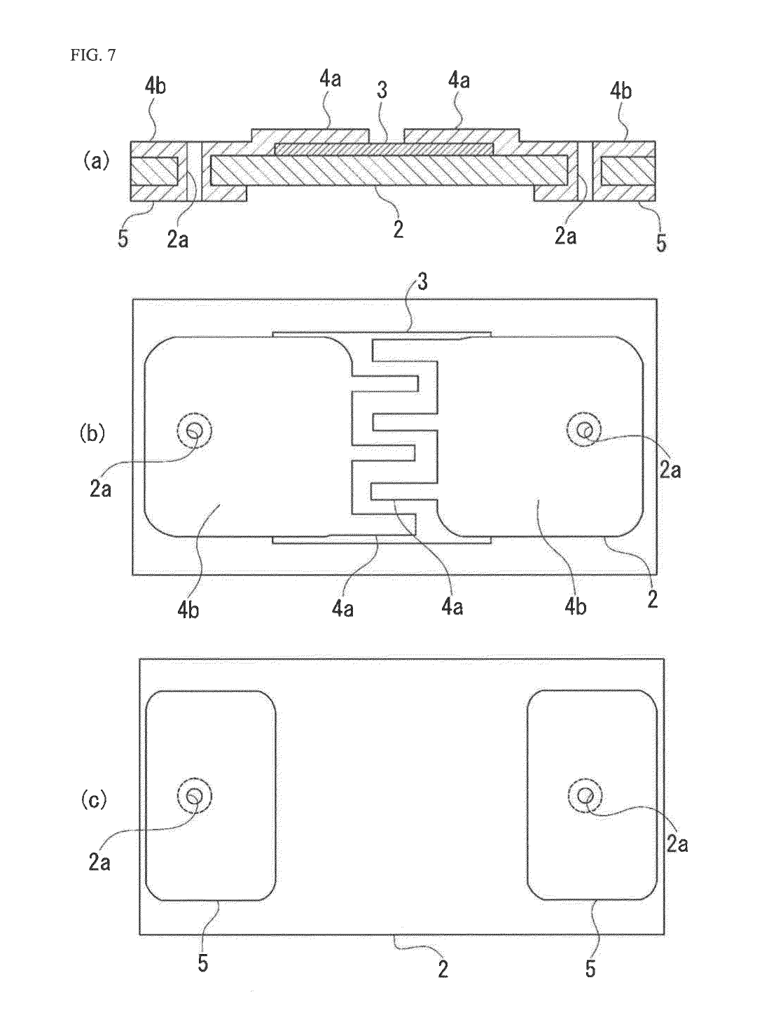

Next, as shown in FIG. 6, a commercially available dry film (8) is formed on the Cu film formed on both sides of the insulating film (2) by heat-compression at a temperature of 110° C. Furthermore, after being exposed by an exposure device, an unnecessary portion is removed by a commercially available developing solution, and then an unnecessary electrode portion is subject to wet etching sequentially using commercially available Cu etchant and Cr etchant. Note that the dry film (8) is hatched as shown in FIGS. 6(b) and 6(c). Furthermore, the dry film (8) is removed by a commercially available stripping solution, so that the front side pattern electrodes (4) consisting of the counter electrode parts (4a) and the front side terminal portions (4b) are patterned on the front side of the insulating film (2) and the back side pattern electrodes (5) which are connected with the front side terminal portions (4b) via the via-holes (2a) are patterned on the back side of the insulating film (2) as shown in FIG. 7.

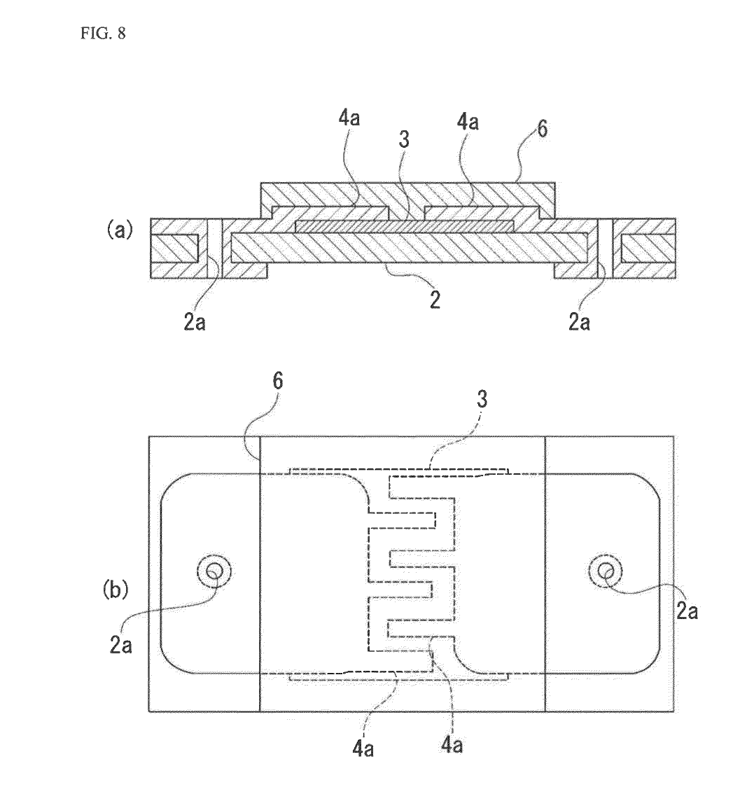

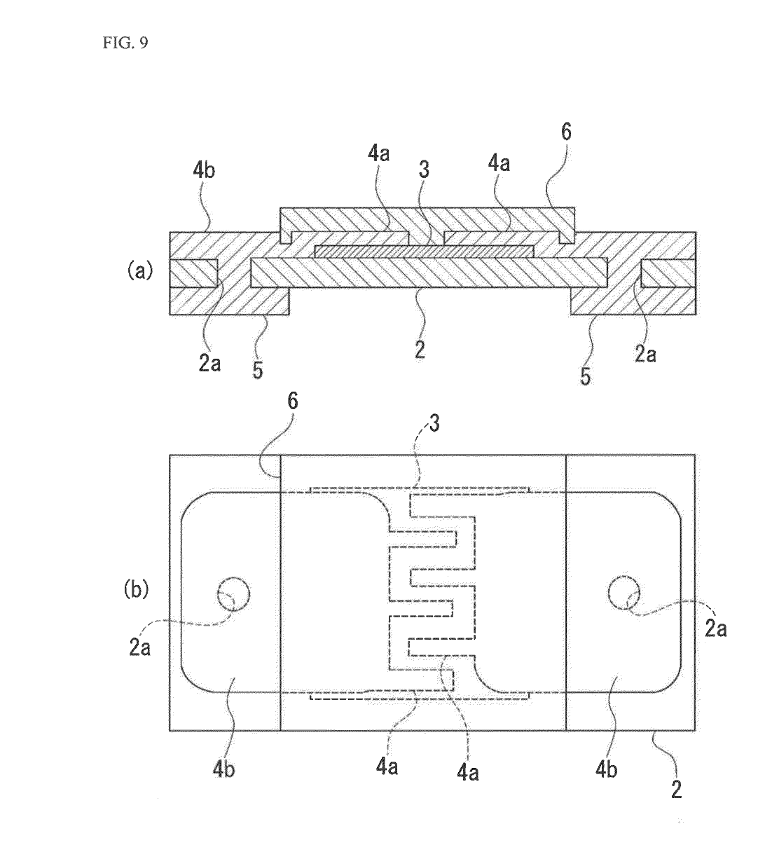

Next, a polyimide resin is screen-printed to cover the thin-film thermistor part (3), and the resulting film is baked at a temperature of 200° C. to thereby form the protective film (6) made of a polyimide resin having a thickness of 25 μm as shown in FIG. 8. Furthermore, the oxidized surface of Cu coated on the front side terminal portions (4b) and the back side pattern electrodes (5) which are terminal portions on both sides of the insulating film (2) is removed by acid treatment, and then, the via-holes (2a) each having a diameter φ of 25 μm are filled with copper by electro-copper plating as shown in FIG. 9. At this time, copper plating having a thickness of 10 μm is formed on the surfaces of the front side terminal portions (4b) and the back side pattern electrodes (5).

Next, Ni having a thickness of 3 μm is formed on Cu coated on the front side terminal portions (4b) and the back side pattern electrodes (5) and Sn having a thickness of 5 μm is further formed thereon by electroless plating, so that an Ni/Sn plating film (9) is formed on the surface layers of the front side terminal portions (4b) and the back side pattern electrodes (5) as shown in FIG. 1.

When a plurality of film-type thermistor sensors (1) is simultaneously produced, the thin-film thermistor part (3), the front side pattern electrodes (4), the back side pattern electrodes (5), the protective film (6), and the like are formed in plural on a large sized sheet of the insulating film (2) as described above, and then the resulting laminated large film is cut into a plurality of film-type thermistor sensors (1).

In this manner, the thin surface-mountable film-type thermistor sensor (1) provided with the terminal portions on both sides thereof, which has a size of 2.0×1.2 mm and a thickness of 0.07 mm, is obtained.

As described above, since, in the film-type thermistor sensor (1) according to the present embodiment, the front side pattern electrodes (4) and the back side pattern electrodes (5) are electrically connected via via-holes (2a) formed so as to penetrate the insulating film (2) with the thin-film thermistor part (3) formed thereon, the film-type thermistor sensor (1) can be directly surface-mounted on a circuit board or the like, so that the back side pattern electrodes (5) or the front side pattern electrodes (4) can be served as terminal portions for electrical connection. Thus, the film-type thermistor sensor (1) which is thin and surface-mountable improves the responsiveness of temperature measurement and can be mounted in small space below an IC or the like mounted on a circuit board or the like. This also allows direct measurement of a temperature of an IC directly below the IC.

In particular, since the film-type thermistor sensor (1) is in a film type using the thin-film thermistor part (3) which is surface-mountable even if it is bent to some extent, the effects specific to a film type sensor, such as the establishment of an electric connection to the back side of the film-type thermistor sensor (1) through the via-holes (2a) for use with semiconductor technology and the suppression of occurrence of cracking or peeling even in a bent or flexed state due to the anchoring effect of the via-holes (2a), can be obtained.

In addition, since the front side pattern electrodes (4) and the back side pattern electrodes (5) serving as terminal portions are respectively formed on the front side and the back side of the insulating film (2), the film-type thermistor sensor (1) can be surface-mounted without differentiating between front and back. Even if either side of the film-type thermistor sensor (1) is surface-mounted, the use of the thin insulating film (2) brings little difference in responsiveness. Furthermore, since the front side pattern electrodes (4) are connected to the back side pattern electrodes (5) via the via-holes (2a), the insulating film (2) is difficult to be peeled off from the front side pattern electrodes (4) or the back side pattern electrodes (5) upon solder mounting due to the anchoring effect.

Furthermore, since the film-type thermistor sensor (1) includes the protective film (6) formed by a resin deposited on the thin-film thermistor part (3), the thin-film thermistor part (3) can be insulated from a substrate or an IC by the presence of the protective film (6) even when the film-type thermistor sensor (1) is surface-mounted with the front side of the insulating film (2) directed toward the substrate or is mounted below the IC. In addition, since the thin-film thermistor part (3) is disposed between the insulating film (2) and the protective film (6) so as to be located approximately at the center in the direction of thickness of the film-type thermistor sensor (1), little difference in responsiveness occurs even when the film-type thermistor sensor (1) is surface-mounted without differentiating between front and back.

Since the thin-film thermistor part (3) consists of a metal nitride represented by the general formula: TiₓAl_{y}N_{z} (where 0.70≦y/(x+y)≦0.95, 0.4≦z≦0.5, and x+y+z=1), wherein the crystal structure thereof is a wurtzite-type single phase having a hexagonal crystal system, the metal nitride material having a good constant B and exhibiting excellent heat resistance may be obtained without baking.

Since the metal nitride material is a columnar crystal extending in a vertical direction to the surface of the film, the crystallinity of the film is high, resulting in obtaining high heat resistance.

Furthermore, since the metal nitride material is strongly oriented along the c-axis more than the a-axis in a vertical direction to the surface of the film, the metal nitride material having a high constant B as compared with the case of a strong a-axis orientation is obtained.

Since, in the method for producing the thermistor material layer (the thin-film thermistor part (3)) of the present embodiment, film deposition is performed by reactive sputtering in a nitrogen-containing atmosphere using a Ti—Al alloy sputtering target, the metal nitride material consisting of the above TiAlN can be deposited on a film without baking.

Since a sputtering gas pressure during the reactive sputtering is set to less than 0.67 Pa, the film made of the metal nitride material, which is strongly oriented along the c-axis more than the a-axis in a vertical direction to the surface of the film, can be formed.

Thus, since, in the film-type thermistor sensor (1) of the present embodiment, the thin-film thermistor part (3) is formed in the form of the thermistor material layer on the insulating film (2), the insulating film (2) having low heat resistance, such as a resin film, can be used by the presence of the thin-film thermistor part (3) which is formed without baking and has a high constant B and high heat resistance, so that a thin and flexible thermistor sensor having an excellent thermistor characteristic is obtained.

Conventionally, a substrate material using a ceramics material such as alumina has often been used. For example, if the substrate material is thinned to a thickness of 0.1 mm, the substrate material is very fragile and easily breakable. In the present invention, a film can be used, so that a very thin film-type thermistor sensor having a thickness of 0.1 mm can be obtained.

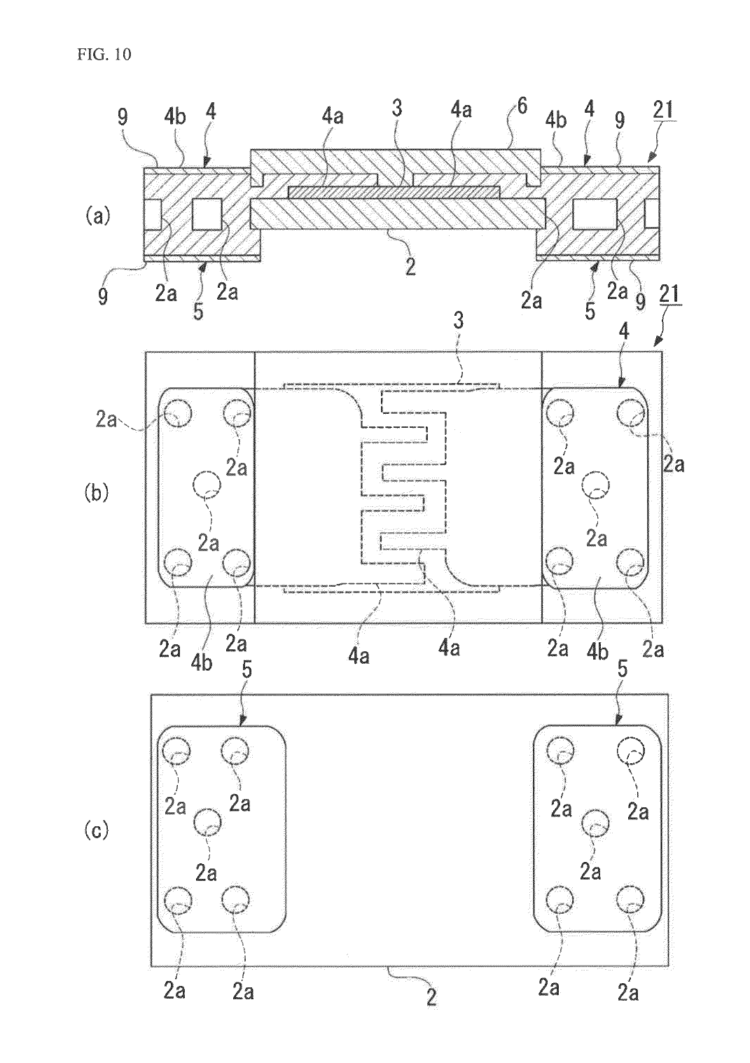

Next, a description will be given below of a film-type thermistor sensor according to a second embodiment of the present invention with reference to FIG. 10. In the following embodiment, the same components as those described in the above embodiment are denoted by the same reference numerals, and description thereof is omitted.

While, in the first embodiment, one via-hole (2a) is disposed for each of the front side pattern electrodes (4), the second embodiment is different from the first embodiment in that, in a film-type thermistor sensor (21) according to the second embodiment, the via-holes (2a) are disposed in plural for each of the front side pattern electrodes (4) and are formed at least near the corners of the front side pattern electrodes (4) or the back side pattern electrodes (5) as shown in FIG. 10.

Specifically, in the second embodiment, five via-holes (2a) are disposed for each of the front side pattern electrodes (4). One via-hole (2a) is formed at the center of the front side terminal portion (4b) and the back side pattern electrode (5) and four via-holes (2a) are formed at four corners of the front side terminal portion (4b) and the back side pattern electrode (5).

As described above, since, in the film-type thermistor sensor (21) according to the second embodiment, the via-holes (2a) are disposed in plural for each of the front side pattern electrodes (4) and are formed at least near the corners of the front side pattern electrodes (4) or the back side pattern electrodes (5), a stronger anchoring effect can be obtained, resulting in an improvement in adhesive strength near the corners of pattern electrodes which are particularly and readily peeled off.

### Examples

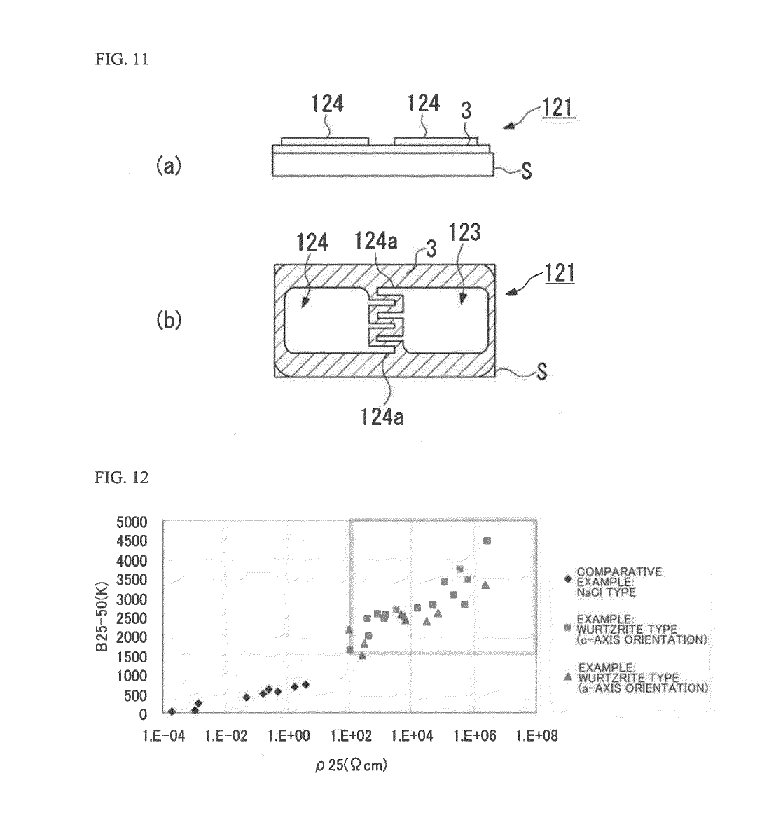

Next, the evaluation results of Examples produced based on the first embodiment with regard to the film-type thermistor sensor according to the present invention will be specifically described with reference to FIGS. 11 to 19.

<Deflection Test Evaluation for Surface-Mounted Film-Type Thermistor Sensor>

A film-type thermistor sensor of Example for a deflection test, which has been produced based on the first embodiment, was mounted on a glass epoxy substrate having a thickness of 0.8 mm by soldering and then was subject to the deflection test. The deflection test was performed under the test conditions in which the film-type thermistor sensor was pressurized from the opposite side of the surface on which the film-type thermistor sensor is mounted by a jig having a radius of curvature of 340 mm at a speed of 0.5 mm per second until the amount of deflection reaches 1 mm, and then was returned to its original state after being held for 10 seconds. A change in electric characteristic of the film-type thermistor sensor was measured before and after the deflection test, and the film-type thermistor sensor was visually observed after the test.

As Comparative Example for a deflection test, a thin-film thermistor part made of transition metal oxide (MnCoNi-based) was formed on an alumina film having a thickness of 0.5 mm, and terminal portions were plated for soldering, so that a thin film thermistor chip having a size of 2.0×1.2×0.07 mm was produced. The film-type thermistor sensor of Comparative Example for a deflection test was also mounted on a glass epoxy substrate having a thickness of 0.8 mm by soldering and then was subject to the deflection test as in Example.

Consequently, although the thin film thermistor chip was cracked in Comparative Example, no cracking or peeling and no visual problem were observed in Example. The thin film thermistor chip in Example exhibited both the rate of change in resistance value and the rate of change in constant B of 0.1% or less, and excellent electric characteristic.

<Production of Film Evaluation Element>

Film evaluation elements 121 shown in FIG. 11 were produced as follows as Examples and Comparative Examples for evaluating the thermistor material layer (the thin-film thermistor part (3)) of the present invention.

Firstly, each of the thin-film thermistor parts 3 having a thickness of 500 nm, which were made of the metal nitride materials formed with various composition ratios as shown in Table 1, was formed on a Si wafer with a thermal oxidation film as a Si substrate S by using Ti—Al alloy targets formed with various composition ratios in the reactive sputtering method. The thin-film thermistor parts 3 were produced under the sputtering conditions of an ultimate degree of vacuum of 5×10⁻⁶ Pa, a sputtering gas pressure of from 0.1 to 1 Pa, a target input power (output) of from 100 to 500 W, and a nitrogen gas fraction under a mixed gas (Ar gas+nitrogen gas) atmosphere of from 10 to 100%.

Next, a Cr film having a thickness of 20 nm was formed and an Au film having a thickness of 200 nm was further formed on the thin-film thermistor parts (3) by the sputtering method. Furthermore, a resist solution was coated on the laminated metal films using a spin coater, and then prebaking was performed for 1.5 mins at a temperature of 110° C. After being exposed by an exposure device, an unnecessary portion was removed by a developing solution, and then pattering was performed by post baking for 5 mins at a temperature of 150° C. Then, an unnecessary electrode portion was subject to wet etching using commercially available Au etchant and Cr etchant, and then the resist was stripped so as to form a pair of pattern electrodes 124 each having a desired comb shaped electrode portion 124a. Then, the resulting elements were diced into chip elements so as to obtain film evaluation elements 121 to be used for evaluating a constant B and for testing heat resistance.

Note that Comparative Examples in which the film evaluation elements 121 respectively have the composition ratios of TiₓAl_{y}N_{z} outside the range of the present invention and have different crystal systems were similarly produced for comparative evaluation.

<Film Evaluation>

### (1) Composition Analysis

The elemental analysis for the thin-film thermistor parts 3 obtained by the reactive sputtering method was performed by X-ray photoelectron spectroscopy (XPS). In the XPS, a quantitative analysis was performed for a sputtering surface up to a depth of 20 nm from the outermost surface by Ar sputtering. The results are shown in Table 1. In the following tables, the composition ratio is represented by “atomic %”.

In the X-ray photoelectron spectroscopy (XPS), a quantitative analysis was performed under the conditions of an X-ray source of MgKα (350 W), a path energy of 58.5 eV, a measurement interval of 0.125 eV, a photo-electron take-off angle with respect to a sample surface of 45 deg, and an analysis area of about 800 μmφ. For the quantification accuracy, the quantification accuracy of N/(Ti+Al+N) was ±2%, and the quantification accuracy of Al/(Ti+Ai) was ±1%.

### (2) Specific Resistance Measurement

The specific resistance of each of the thin-film thermistor parts 3 obtained by the reactive sputtering method was measured by the four-probe method at a temperature of 25° C. The results are shown in Table 1.

### (3) Measurement of Constant B

The resistance value for each of the film evaluation elements 121 at temperatures of 25° C. and 50° C. was measured in a constant temperature bath, and a constant B was calculated based on the resistance values at temperatures of 25° C. and 50° C. The results are shown in Table 1.

In the constant B calculating method of the present invention, the constant B is calculated by the following formula using the resistance values at temperatures of 25° C. and 50° C.

Constant B(K)=ln(R25/R50)/(1/T25−1/T50)

R25 (Ω): resistance value at 25° C.

R50 (Ω): resistance value at 50° C.

T25 (K): 298.15 K which is absolute temperature of 25° C. expressed in Kelvin

T50 (K): 323.15 K which is absolute temperature of 50° C. expressed in Kelvin

As can be seen from these results, a thermistor characteristic having a resistivity of 100 Ωcm or greater and a constant B of 1500 K or greater is achieved in all Examples in which the composition ratio of TiₓAl_{y}N_{z} falls within the region enclosed by the points A, B, C, and D in the Ti—Al—N-based ternary phase diagram as shown in FIG. 2, i.e., the region where “0.70≦y/(x+y)≦0.95, 0.4≦z≦0.5, and x+y+z=1”.

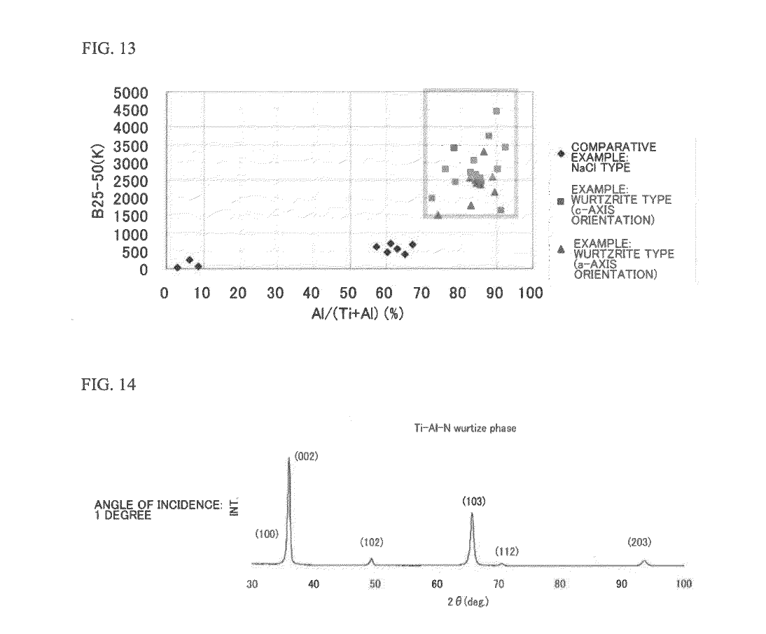

From the above results, a graph illustrating the relationship between a resistivity at 25° C. and a constant B is shown in FIG. 12. Also, a graph illustrating the relationship between the Al/(Ti+Al) ratio and the constant B is shown in FIG. 13. From these graphs, the film evaluation elements 121 which fall within the region where Al/(Ti+Al) is from 0.7 to 0.95 and N/(Ti+Al+N) is from 0.4 to 0.5 and the crystal system thereof is a hexagonal wurtzite-type single phase have a specific resistance value at a temperature of 25° C. of 100 Ωcm or greater and a constant B of 1500 K or greater, and thus, fall within the region of high resistance and high constant B. In data shown in FIG. 13, the reason why the constant B varies with respect to the same Al/(Ti+Al) ratio is because the film evaluation elements 121 have different amounts of nitrogen in their crystals.

Comparative Examples 3 to 12 shown in Table 1 fall within the region where Al/(Ti+Al)<0.7, and the crystal system thereof is a cubic NaCl-type phase. In Comparative Example 12 (Al/(Ti+Al)=0.67), a NaCl-type phase and a wurtzrite-type phase coexist. Thus, the region where Al/(Ti+Al)<0.7 exhibits a specific resistance value at a temperature of 25° C. of less than 100 Ωcm and a constant B of less than 1500 K, and thus, is a region of low resistance and low constant B.

Comparative Examples 1 and 2 shown in Table 1 fall within the region where N/(Ti+Al+N) is less than 40%, and thus, are in a crystal state where nitridation of metals contained therein is insufficient. Comparative Examples 1 and 2 were neither a NaCl-type nor a wurtzite-type and had very poor crystallinity. In addition, it was found that Comparative Examples 1 and 2 exhibited near-metallic behavior because both the constant B and the resistance value were very small.

### (4) Thin Film X-Ray Diffraction (Identification of Crystal Phase)

The crystal phases of the thin-film thermistor parts 3 obtained by the reactive sputtering method were identified by Grazing Incidence X-ray Diffraction. The thin film X-ray diffraction is a small angle X-ray diffraction experiment. Measurement was performed under the condition of a vessel of Cu, the angle of incidence of 1 degree, and 2θ of from 20 to 130 degrees. Some of the samples were measured under the condition of the angle of incidence of 0 degree and 2θ of from 20 to 100 degrees.

As a result of measurement, a wurtzrite-type phase (hexagonal, the same phase as that of AlN) was obtained in the region where Al/(Ti+Al)≧0.7, whereas a NaCl-type phase (cubic, the same phase as that of TiN) was obtained in the region where Al/(Ti+Al)<0.65. A crystal phase in which a wurtzrite-type phase and a NaCl-type phase coexist was obtained in the region where 0.65<Al/(Ti+Al)<0.7.

Thus, in the Ti—Al—N-based metal nitride material, the region of high resistance and high constant B exists in the wurtzrite-type phase where Al/(Ti+Al)≧0.7. In Examples of the present invention, no impurity phase was confirmed and the crystal structure thereof was a wurtzrite-type single phase.

In Comparative Examples 1 and 2 shown in Table 1, the crystal phase thereof was neither a wurtzrite-type phase nor a NaCl-type phase as described above, and thus, could not be identified in the testing. In these Comparative Examples, the peak width of XRD was very large, resulting in obtaining materials exhibiting very poor crystallinity. It is contemplated that the crystal phase thereof was a metal phase with insufficient nitridation because Comparative Examples 1 and 2 exhibited near-metallic behavior from the viewpoint of electric characteristics.

TABLE 1

| | | XRD PEAK | CRYSTAL AXIS | |
|---|---|---|---|---|
| | | INTENSITY | EXHIBITING STRONG | |
| | | RATIO OF | DEGREE OF ORIENTATION | SPUT- |
| | | (100)/(002) | IN VERTICAL DIRECTION | TERING |
| | | WHEN CRYSTAL | TO SUBSTRATE SURFACE | GAS |
| | | PHASE IS | WHEN CRYSTAL PHASE IS | PRES- |
| | CRYSTAL | WURTZRITE | WURTZRITE TYPE PHASE | SURE |
| | SYSTEM | TYPE PHASE | (a-AXIS OR c-AXIS) | (Pa) |
| COMPARATIVE | UNKNOWN | — | | — |
| EXAMPLE 1 | (INSUFFICIENT | | | |
| | NITRIDATION) | | | |
| COMPARATIVE | UNKNOWN | — | | — |
| EXAMPLE 2 | (INSUFFICIENT | | | |
| | NITRIDATION) | | | |
| COMPARATIVE | NaCl TYPE | — | | — |
| EXAMPLE 3 | | | | |
| COMPARATIVE | NaCl TYPE | — | | — |
| EXAMPLE 4 | | | | |
| COMPARATIVE | NaCl TYPE | — | | — |
| EXAMPLE 5 | | | | |
| COMPARATIVE | NaCl TYPE | — | | — |
| EXAMPLE 6 | | | | |
| COMPARATIVE | NaCl TYPE | — | | — |
| EXAMPLE 7 | | | | |
| COMPARATIVE | NaCl TYPE | — | | — |
| EXAMPLE 8 | | | | |
| COMPARATIVE | NaCl TYPE | — | | — |
| EXAMPLE 9 | | | | |
| COMPARATIVE | NaCl TYPE | — | | — |
| EXAMPLE 10 | | | | |
| COMPARATIVE | NaCl TYPE | — | | — |
| EXAMPLE 11 | | | | |
| COMPARATIVE | NaCl TYPE + | — | | — |
| EXAMPLE 12 | WURTZRITE TYPE | | | |
| EXAMPLE 1 | WURTZRITE TYPE | 0.05 | c-AXIS | <0.67 |
| EXAMPLE 2 | WURTZRITE TYPE | 0.07 | c-AXIS | <0.67 |
| EXAMPLE 3 | WURTZRITE TYPE | 0.45 | c-AXIS | <0.67 |
| EXAMPLE 4 | WURTZRITE TYPE | <0.01 | c-AXIS | <0.67 |
| EXAMPLE 5 | WURTZRITE TYPE | 0.34 | c-AXIS | <0.37 |
| EXAMPLE 6 | WURTZRITE TYPE | <0.01 | c-AXIS | <0.67 |
| EXAMPLE 7 | WURTZRITE TYPE | 0.09 | c-AXIS | <0.67 |
| EXAMPLE 8 | WURTZRITE TYPE | 0.05 | c-AXIS | <0.67 |
| EXAMPLE 9 | WURTZRITE TYPE | <0.01 | c-AXIS | <0.67 |
| EXAMPLE 10 | WURTZRITE TYPE | 0.04 | c-AXIS | <0.67 |
| EXAMPLE 11 | WURTZRITE TYPE | 0.24 | c-AXIS | <0.67 |
| EXAMPLE 12 | WURTZRITE TYPE | 0.73 | c-AXiS | <0.67 |
| EXAMPLE 13 | WURTZRITE TYPE | <0.01 | c-AXIS | <0.67 |
| EXAMPLE 14 | WURTZRITE TYPE | 0.38 | c-AXIS | <0.67 |
| EXAMPLE 15 | WURTZRITE TYPE | 0.13 | c-AXIS | <0.67 |
| EXAMPLE 16 | WURTZRITE TYPE | 3.54 | a-AXIS | ≧0.67 |
| EXAMPLE 17 | WURTZRITE TYPE | 2.94 | a-AXIS | ≧0.67 |
| EXAMPLE 18 | WURTZRITE TYPE | 1.05 | a-AXIS | ≧0.67 |
| EXAMPLE 19 | WURTZRITE TYPE | 2.50 | a-AXIS | ≧0.67 |
| EXAMPLE 20 | WURTZRITE TYPE | 9.09 | a-AXIS | ≧0.67 |
| EXAMPLE 21 | WURTZRITE TYPE | 6.67 | a-AXIS | ≧0.67 |
| EXAMPLE 22 | WURTZRITE TYPE | 2.22 | a-AXIS | ≧0.67 |
| EXAMPLE 23 | WURTZRITE TYPE | 1.21 | a-AXIS | ≧0.67 |
| EXAMPLE 24 | WURTZRITE TYPE | 3.33 | a-AXIS | ≧0.67 |

| | | | | | RESULT OF ELECTRIC PROPERTIES | |
|---|---|---|---|---|---|---|
| | COMPOSITION RATIO | | | | | SPECIFIC |
| | | | | Al/ | B | RESISTANCE |
| | | | | (Ti + | CON- | VALUE AT |
| | | | | Al) | STANT | 25° C. |
| | Ti(%) | Al(%) | N(%) | (%) | (K) | (Ω cm) |
| COMPARATIVE | 29 | 43 | 28 | 60 | <0 | 2.E−04 |
| EXAMPLE 1 | | | | | | |
| COMPARATIVE | 16 | 54 | 30 | 77 | 25 | 4.E−04 |
| EXAMPLE 2 | | | | | | |
| COMPARATIVE | 50 | 0 | 50 | 0 | <0 | 2.E−05 |
| EXAMPLE 3 | | | | | | |
| COMPARATIVE | 47 | 1 | 52 | 3 | 30 | 2.E−04 |
| EXAMPLE 4 | | | | | | |
| COMPARATIVE | 51 | 3 | 46 | 6 | 248 | 1.E−03 |
| EXAMPLE 5 | | | | | | |
| COMPARATIVE | 50 | 5 | 45 | 9 | 69 | 1.E−03 |
| EXAMPLE 6 | | | | | | |
| COMPARATIVE | 23 | 30 | 47 | 57 | 622 | 3.E−01 |
| EXAMPLE 7 | | | | | | |
| COMPARATIVE | 22 | 33 | 45 | 60 | 477 | 2.E−01 |
| EXAMPLE 8 | | | | | | |
| COMPARATIVE | 21 | 32 | 47 | 61 | 724 | 4.E+00 |
| EXAMPLE 9 | | | | | | |
| COMPARATIVE | 20 | 34 | 46 | 63 | 564 | 5.E−01 |
| EXAMPLE 10 | | | | | | |
| COMPARATIVE | 19 | 35 | 46 | 65 | 402 | 5.E−02 |
| EXAMPLE 11 | | | | | | |
| COMPARATIVE | 18 | 37 | 45 | 67 | 665 | 2.E+00 |
| EXAMPLE 12 | | | | | | |
| EXAMPLE 1 | 15 | 38 | 47 | 72 | 1980 | 4.E+02 |
| EXAMPLE 2 | 12 | 38 | 50 | 76 | 2798 | 5.E+04 |
| EXAMPLE 3 | 11 | 42 | 47 | 79 | 3385 | 1.E+05 |
| EXAMPLE 4 | 11 | 41 | 46 | 79 | 2437 | 4.E+02 |
| EXAMPLE 5 | 9 | 43 | 48 | 83 | 2727 | 2.E+04 |
| EXAMPLE 6 | 8 | 42 | 50 | 84 | 3057 | 2.E+05 |
| EXAMPLE 7 | 8 | 44 | 48 | 84 | 2665 | 3.E+03 |
| EXAMPLE 8 | 8 | 44 | 48 | 85 | 2527 | 1.E+03 |
| EXAMPLE 9 | 8 | 45 | 47 | 86 | 2557 | 8.E+02 |
| EXAMPLE 10 | 7 | 46 | 46 | 86 | 2449 | 1.E+03 |
| EXAMPLE 11 | 7 | 48 | 45 | 88 | 3729 | 4.E+05 |
| EXAMPLE 12 | 5 | 49 | 46 | 90 | 2798 | 5.E+05 |
| EXAMPLE 13 | 5 | 45 | 50 | 90 | 4449 | 3.E+06 |
| EXAMPLE 14 | 5 | 50 | 45 | 91 | 1621 | 1.E+02 |
| EXAMPLE 15 | 4 | 50 | 46 | 93 | 3439 | 6.E+05 |
| EXAMPLE 16 | 15 | 43 | 42 | 74 | 1507 | 3.E+02 |
| EXAMPLE 17 | 10 | 49 | 41 | 83 | 1794 | 3.E+02 |
| EXAMPLE 18 | 6 | 52 | 42 | 90 | 2164 | 1.E+02 |
| EXAMPLE 19 | 9 | 44 | 47 | 83 | 2571 | 5.E+03 |
| EXAMPLE 20 | 8 | 46 | 46 | 84 | 2501 | 6.E+03 |
| EXAMPLE 21 | 8 | 45 | 47 | 84 | 2408 | 7.E+03 |
| EXAMPLE 22 | 8 | 46 | 46 | 86 | 2364 | 3.E+04 |
| EXAMPLE 23 | 7 | 46 | 47 | 87 | 3317 | 2.E+06 |
| EXAMPLE 24 | 6 | 51 | 43 | 89 | 2599 | 7.E+04 |

Next, all of Examples in the present invention were wurtzrite-type phase films having strong orientation. Thus, whether the films have strong a-axis orientation or c-axis orientation to the crystal axis in a vertical direction (film thickness direction) to the Si substrate S was examined by XRD. At this time, in order to examine the orientation of crystal axis, the peak intensity ratio of (100)/(002) was measured, where (100) is the Miller index indicating a-axis orientation and (002) is the Miller index indicating c-axis orientation.

Consequently, in Examples in which film deposition was performed at a sputtering gas pressure of less than 0.67 Pa, the intensity of (002) was much stronger than that of (100), so that the films exhibited stronger c-axis orientation than a-axis orientation. On the other hand, in Examples in which film deposition was performed at a sputtering gas pressure of 0.67 Pa or greater, the intensity of (100) was much stronger than that of (002), so that the films exhibited stronger a-axis orientation than c-axis orientation.

Note that it was confirmed that a wurtzrite-type single phase was formed in the same manner even when the thin-film thermistor part (3) was deposited on a polyimide film under the same deposition condition. In addition, it was confirmed that the crystal orientation did not change even when the thin-film thermistor part (3) was deposited on a polyimide film under the same deposition condition.

An exemplary XRD profile in Example exhibiting strong c-axis orientation is shown in FIG. 14. In this Example, Al/(Ti+Al) was equal to 0.84 (wurtzrite-type, hexagonal), and measurement was performed at the angle of incidence of 1 degree. As can be seen from the result in this Example, the intensity of (002) was much stronger than that of (100).

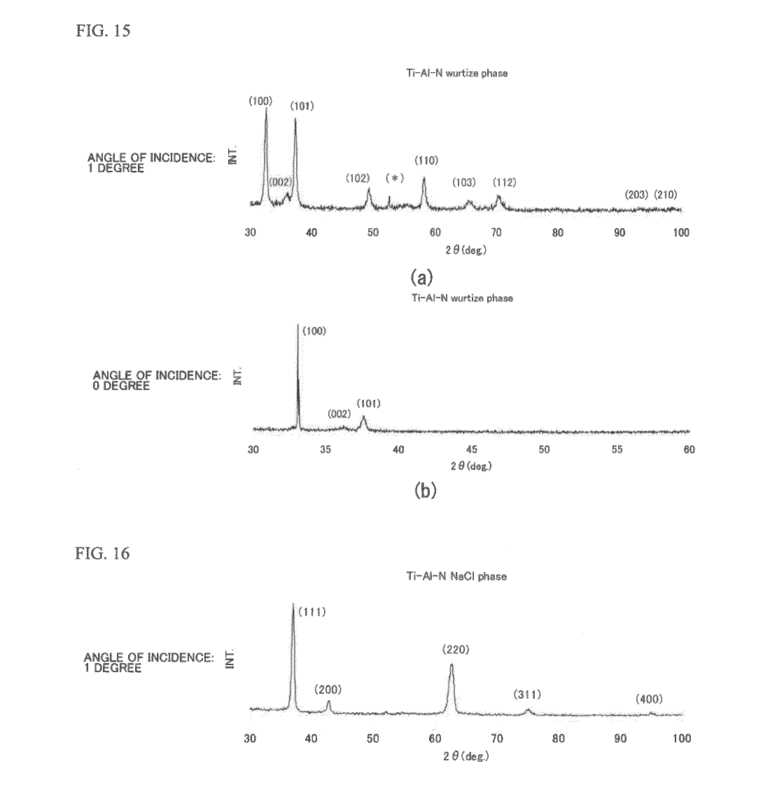

An exemplary XRD profile in Example exhibiting strong a-axis orientation is shown in FIG. 15. In this Example, Al/(Ti+Al) was equal to 0.83 (wurtzrite-type, hexagonal), measurement was performed at the angle of incidence of 1 degree. As can be seen from the result in this Example, the intensity of (100) was much stronger than that of (002).

Furthermore, in this Example, symmetrical reflective measurement was performed at the angle of incidence of 0 degrees. The asterisk (*) in the graph was a peak derived from the device, and thus, it was confirmed that the asterisk (*) in the graph is neither a peak derived from the sample itself nor a peak derived from the impurity phase (it can be seen from that fact that the peak indicated by (*) is lost in the symmetrical reflective measurement, and thus, it is a peak derived from the device).

An exemplary XRD profile in Comparative Example is shown in FIG. 16. In this Comparative Example, AI/(Ti+Al) was equal to 0.6 (NaCl type, cubic), and measurement was performed at the angle of incidence of 1 degree. No peak which could be indexed as a wurtzrite-type (space group P6₃mc (No. 186)) was detected, and thus, this Comparative Example was confirmed as a NaCl-type single phase.

Next, the correlation between a crystal structure and its electric characteristic was compared in detail with each other with regard to Examples of the present invention in which the wurtzrite-type materials were employed.

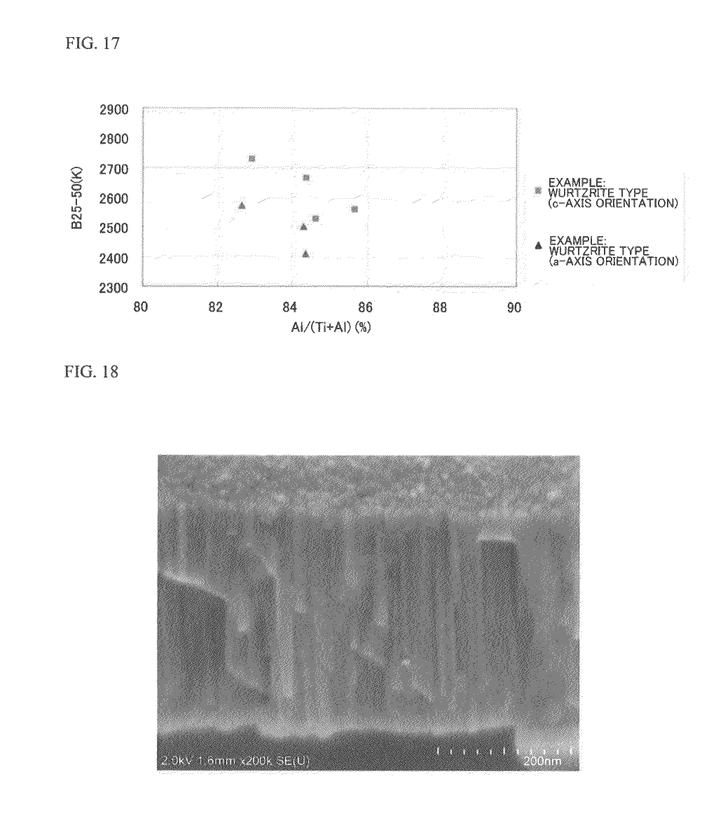

As shown in Table 2 and FIG. 17, there were materials (Examples 5, 7, 8, and 9) of which the crystal axis is strongly oriented along a c-axis in a vertical direction to the surface of the substrate and materials (Examples 19, 20, and 21) of which the crystal axis is strongly oriented along an a-axis in a vertical direction to the surface of the substrate despite the fact that they have substantially the same Al/(Ti+Al) ratio.

When both groups were compared to each other, it was found that the materials having a strong c-axis orientation had a greater constant B by about 100 K than that of the materials having a strong a-axis orientation upon the same Al/(Ti+Al) ratio. When focus was placed on the amount of N (N/(Ti+Al+N)), it was found that the materials having a strong c-axis orientation had a slightly larger amount of nitrogen than that of the materials having a strong a-axis orientation. Since the ideal stoichiometric ratio of N/(Ti+Al+N) is 0.5, it was found that the materials having a strong c-axis orientation were ideal materials due to a small amount of nitrogen defects.

TABLE 2

| | | XRD PEAK | CRYSTAL AXIS | | | | | | | |
|---|---|---|---|---|---|---|---|---|---|---|
| | | INTENSITY | EXHIBITING STRONG | | | | | | RESULT OF ELECTRIC | |
| | | RATIO OF | DEGREE OF ORIENTATION | SPUT- | | | | | PROPERTIES | |
| | | (100)/(002) | IN VERTICAL DIRECTION | TERING | COMPOSITION RATIO | | | | | SPECIFIC |
| | | WHEN CRYSTAL | TO SUBSTRATE SURFACE | GAS | | | | Al/ | B | RESISTANCE |
| | | PHASE IS | WHEN CRYSTAL PHASE IS | PRES- | | | | (Ti + | CON- | VALUE AT |
| | CRYSTAL | WURTZRITE | WURTZRITE TYPE PHASE | SURE | | | | Al) | STANT | 25° C. |
| | SYSTEM | TYPE PHASE | (a-AXIS OR c-AXIS) | (Pa) | Ti(%) | Al(%) | N(%) | (%) | (K) | (Ω cm) |
| EXAM | WURTZRITE | 0.34 | c-AXIS | <0.67 | 9 | 43 | 48 | 83 | 2727 | 2.E+04 |
| PLE 5 | TYPE | | | | | | | | | |
| EXAM- | WURTZRITE | 0.09 | c-AXIS | <0.67 | 8 | 44 | 48 | 84 | 2665 | 3.E+03 |
| PLE 7 | TYPE | | | | | | | | | |
| EXAM- | WURTZRITE | 0.05 | c-AXIS | <0.67 | 8 | 44 | 48 | 85 | 2527 | 1.E+03 |
| PLE 8 | TYPE | | | | | | | | | |
| EXAM- | WURTZRITE | <0.01 | c-AXIS | <0.67 | 8 | 45 | 47 | 86 | 2557 | 8.E+02 |
| PLE 9 | TYPE | | | | | | | | | |
| EXAM- | WURTZRITE | 2.50 | a-AXIS | ≧0.67 | 9 | 44 | 47 | 83 | 2571 | 5.E+03 |
| PLE 19 | TYPE | | | | | | | | | |
| EXAM- | WURTZRITE | 9.09 | a-AXIS | ≧0.67 | 8 | 46 | 46 | 84 | 2501 | 6.E+03 |
| PLE 20 | TYPE | | | | | | | | | |
| EXAM- | WURTZRITE | 6.67 | a-AXIS | ≧0.67 | 8 | 45 | 47 | 84 | 2408 | 7.E+03 |
| PLE 21 | TYPE | | | | | | | | | |

<Crystal Form Evaluation>

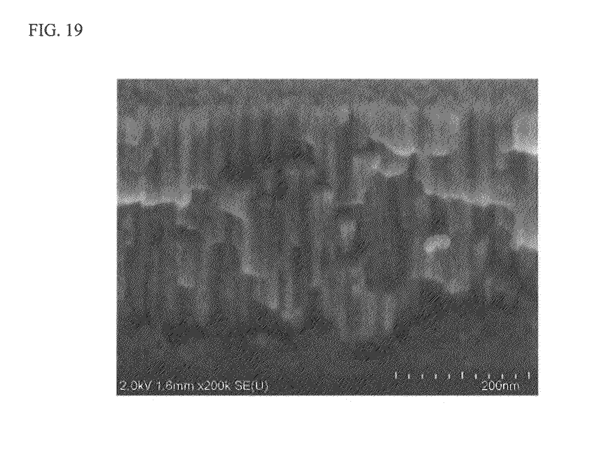

Next, as an exemplary crystal form in the cross-section of the thin-film thermistor part (3), a cross-sectional SEM photograph of the thin-film thermistor part (3) in Example (Al/(Ti+Al)=0.84, wurtzrite-type, hexagonal, and strong c-axis orientation) in which the thin-film thermistor part (3) was deposited on the Si substrate S with a thermal oxidation film is shown in FIG. 18. Also, a cross-sectional SEM photograph of the thin-film thermistor part (3) in another Example (Al/(Ti+Al)=0.83, wurtzrite-type, hexagonal, and strong a-axis orientation) is shown in FIG. 19.

The samples in these Examples were obtained by breaking the Si substrates S by cleaving them. The photographs were taken by tilt observation at the angle of 45 degrees.

As can be seen from these photographs, samples were formed of a high-density columnar crystal in both Examples. Specifically, the growth of columnar crystal in a direction perpendicular to the surface of the substrate was observed in Example revealing a strong c-axis orientation and another Example revealing a strong a-axis orientation. Note that the break of the columnar crystal was generated upon breaking the Si substrate S by cleaving it.

<Film Heat Resistance Test Evaluation>

In Examples and Comparative Example shown in Table 3, a resistance value and a constant B before and after the heat resistance test at a temperature of 125° C. for 1000 hours in air were evaluated. The results are shown in Table 3. Comparative Example made by a conventional Ta—Al—N-based material was also evaluated in the same manner for comparison.

As can be seen from these results, although the Al concentration and the nitrogen concentration vary, the heat resistance of the Ti—Al—N-based material based on the electric characteristic change before and after the heat resistance test is better than the Ta—Al—N-based material in Comparative Example when comparison is made by using the same constant B. Note that the materials used in Examples 5 and 8 have a strong c-axis orientation and the materials used in Examples 21 and 24 have a strong a-axis orientation. When both groups were compared to each other, the heat resistance of Examples revealing a strong c-axis orientation is slightly improved as compared with that of Examples revealing a strong a-axis orientation.

Note that, in the Ta—Al—N-based material, ionic radius of Ta is very high compared to that of Ti and Al, and thus, a wurtzrite-type phase cannot be produced in the high-concentration Al region. It is contemplated that the Ti—Al—N-based material having the wurtzrite-type phase has better heat resistance than the Ta—Al—N-based material because the Ta—Al—N-based material is not the wurtzrite-type phase.

TABLE 3

| | | | | | | | | RISING RATE | RESISTANCE |
|---|---|---|---|---|---|---|---|---|---|
| | | | | | | | SPECIFIC | OF SPECIFIC | TEST AT |
| | | | | | | | RESISTANCE | RESISTANCE | 125° C. |
| | | | | | | | VALUE AT | AT 25° C. | FOR 1,000 |
| | M | | | | Al/(M + Al) | B25-50 | 25° C. | AFTER HEAT | HOURS |
| | ELEMENT | M(%) | Al(%) | N(%) | (%) | (K) | (Ω cm) | (%) | (%) |
| COMPARATIVE | Ta | 60 | 1 | 39 | 2 | 2671 | 5.E+02 | 25 | 16 |
| EXAMPLE | | | | | | | | | |
| EXAMPLE 5 | Ti | 9 | 43 | 48 | 83 | 2727 | 2.E+04 | <4 | <1 |
| EXAMPLE 8 | Ti | 8 | 44 | 48 | 85 | 2527 | 1.E+03 | <4 | <1 |
| EXAMPLE 21 | Ti | 8 | 45 | 47 | 84 | 2408 | 7.E+03 | <5 | <1 |
| EXAMPLE 24 | Ti | 6 | 51 | 43 | 89 | 2599 | 7.E+04 | <5 | <1 |

The technical scope of the present invention is not limited to the aforementioned embodiments and Examples, but the present invention may be modified in various ways without departing from the scope or teaching of the present invention.

For example, while, in the above embodiments, the thin-film thermistor part made of TiAlN is preferred as described above, the thin-film thermistor part made of another thermistor material may also be employed. While, in the above embodiments, the front side pattern electrodes (counter electrode parts) are formed on the thin-film thermistor part, the front side pattern electrode may also be formed under the thin-film thermistor part.

### REFERENCE NUMERALS

1 and 21: film-type thermistor sensor, 2: insulating film, 2a: via-hole, 3: thin-film thermistor part, 4: front side pattern electrode, 4a: counter electrode part, 5: back side pattern electrode, 6: protective film

What is claimed is:

1. A film-type thermistor sensor comprising:
an insulating film;
a thin-film thermistor part formed on the front side of the insulating film;
a pair of front side pattern electrodes in which a pair of counter electrode parts facing each other is disposed above or below the thin-film thermistor part and is formed on the front side of the insulating film; and
a pair of back side pattern electrodes formed on the back side of the insulating film in such a manner as to face a part of the pair of front side pattern electrodes,
wherein the front side pattern electrodes and the back side pattern electrodes are electrically connected via via-holes formed so as to penetrate the insulating film.

2. The film-type thermistor sensor according to claim 1, wherein the via-holes are disposed in plural for each of the front side pattern electrodes and are formed at least near the corners of the front side pattern electrodes or the back side pattern electrodes.

3. The film-type thermistor sensor according to claim 1, further comprising:
a protective film formed by a resin deposited on the thin-film thermistor part.

4. The film-type thermistor sensor according to claim 1, wherein the thin-film thermistor part consists of a metal nitride represented by the general formula: TiₓAl_{y}N_{z} (where 0.70≦y/(x+y)≦0.95, 0.4≦z≦0.5, and x+y+z=1), and the crystal structure thereof is a hexagonal wurtzite-type single phase.
